(19) United States
(12) Patent Application Publication
(10) Pub. No.: US 2014/0298947 A1
(43) Pub. Date: Oct. 9, 2014

(54) CLUTCH PEDAL ASSEMBLY WITH DRIVER SELECTABLE LOAD ASSIST

(71) Applicant: GM GLOBAL TECHNOLOGY OPERATIONS LLC, Detroit, MI (US)

(72) Inventors: Greg Alan Weeter, Ann Arbor, MI (US); Karl Kollin, Commerce Township, MI (US)

(73) Assignee: GM Global Technology Operations LLC, Detroit, MI (US)

(21) Appl. No.: 13/856,107

(22) Filed: Apr. 3, 2013

(51) Int. Cl. G05G 1/44

(52) U.S. Cl. CPC G05G 1/44
USPC 74/512

(57) ABSTRACT

A clutch pedal assembly for an automotive transmission is provided. The clutch pedal assembly includes a clutch pedal lever for disengaging a clutch of a vehicular transmission. The clutch pedal lever has a depressed position and a return position. A biasing member is coupled to the clutch pedal lever. A structural member has a first portion and a second portion. The biasing member is selectively connectable to the first and second portions of the structural member.

### FIELD

The present disclosure relates to clutch pedal mechanisms for automotive vehicles, and more particularly, to a clutch pedal mechanism having a feature for reducing the effort required to depress a clutch pedal.

### BACKGROUND

The statements in this section merely provide background information related to the present disclosure and may not constitute prior art.

A vehicle with a manually shiftable transmission typically has a clutch pedal mechanism that operates a clutch to selectively decouple the engine from the transmission during shift events. The clutch pedal mechanism includes a clutch pedal lever pivoted on a mount or other stationary support member. The clutch pedal lever generally has two positions, one of which corresponds to the clutch disengaged position and a depressed state of the clutch pedal lever, and the other of which corresponds to the clutch engaged position and the return state of the clutch pedal lever. When the clutch pedal lever is depressed and the clutch is in the disengaged position, typically, the engine is decoupled from the transmission. When the clutch pedal lever is in the return state and not depressed, the engine and transmission may be coupled in any gear range or the engine and transmission may be decoupled in neutral.

One or more assist-springs are typically provided to reduce the pedal effort required by the operator to move the clutch pedal lever into the depressed position wherein the clutch is in the clutch engaged position. Typically, the assist-spring acts on the clutch pedal lever starting at a position wherein the clutch pedal is partially depressed. When a clutch pedal is partially depressed to an assist position, the assist-spring exerts a force on the clutch pedal lever to help move the clutch pedal lever into the fully depressed position wherein the clutch is in the disengaged position. The assist-spring is effective in reducing the clutch pedal force required by the operator to disengage the clutch.

Unfortunately, clutch pedal assemblies having an assist-spring have the drawback of a slower shift response than may be desired by a percentage of the population, particularly operators that are interested in quickly shifting to gain speed faster. Such operators have been known to remove the assist-spring to reduce shift time. However, removing the assist-spring may damage the clutch pedal assembly.

Accordingly, there exists a need for a shifting system that allows for fasting shifting without the risk of damaging the clutch pedal assembly.

### SUMMARY

The present disclosure provides a clutch pedal having a driver selectable feature for varying the clutch assist load between a maximum assist load (for comfort) and a minimum assist load (for performance). The selectable feature includes an anchor point for the pedal assist spring that the driver can adjust for personal load choice. For example, the anchor point could be adjusted in a track or slot, with a lever and a cam friction brake to retain the assist spring in place.

In one variation, which may be combined with or separate from the other variations described herein, a clutch pedal assembly for an automotive transmission is provided. The clutch pedal assembly includes a clutch pedal lever for disengaging a clutch of a vehicular transmission. The clutch pedal lever has a depressed position and a return position. A biasing member, such as a spring, is coupled to the clutch pedal lever. The biasing member is configured to bias the clutch pedal lever into the depressed position. A structural member has a first portion and a second portion. The biasing member is selectively connectable to the first and second portions of the structural member.

In another variation, which may be combined with or separate from the other variations described herein, a clutch pedal assembly for an automotive transmission is provided. The clutch pedal assembly includes a structural member having a first portion and a second portion. The first portion defines a first groove therein, and the second portion defining a second groove therein. A clutch pedal lever is included for disengaging a clutch of a vehicular transmission. The clutch pedal lever has a depressed position and a return position. The clutch pedal lever is rotatably coupled to the structural member. A pedal biasing member, such as a spring, is coupled to the clutch pedal lever. A locking element is coupled to the pedal biasing member. The locking element is selectively connectable to the first and second portions of the structural member in the first and second grooves.

In yet another variation, which may be combined with or separate from the other variations described herein, a clutch pedal assembly for an automotive transmission is provided. The clutch pedal assembly includes a clutch pedal lever for disengaging a clutch of a vehicular transmission. The clutch pedal lever has a depressed position, an intermediate position, and a return position. A pedal biasing member, such as a spring, is coupled to the clutch pedal lever. A structural member is included; the structural member has a first portion defining a first groove therein and a second portion defining a second groove therein. The structural member defines a first slot therein extending from the first portion to the second portion, and the structural member further defines a second slot therein. The clutch pedal lever is pivotally coupled to the structural member.

A rod is coupled to the pedal biasing member. The rod is disposed through the first and second slots of the structural member, and the rod is slidable within the first slot between the first portion and the second portion of the structural member. The rod has a first end and a second end. A locking part is coupled to the first end of the rod. The locking part is configured to selectively lock the pedal biasing member to the first portion of the structural member in the first groove in a comfort state, and the locking part is configured to selectively lock the pedal biasing member to the second portion of the structural member in the second groove in a performance state. An end stop is disposed on the second end of the rod. A rod biasing member is disposed adjacent to the end stop. The locking element is configured to be moved away from the first and second grooves and to compress the rod biasing member between the end stop and the structural member. The clutch pedal lever requires a first force to press the clutch pedal lever from the return position to the depressed position in the comfort state. The clutch pedal lever requires a second force to press the clutch pedal lever from the return position to the depressed position in the performance state. The second force is greater than the first force. The pedal biasing member is configured to bias the clutch pedal lever into the depressed position when the clutch pedal lever is located between the intermediate position and the depressed position.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a clutch pedal assembly according to the principles of the present disclosure;

FIG. 2 is a close-up perspective view of a portion of the clutch pedal assembly of FIG. 1 locked in a comfort state, in accordance with the principles of the present disclosure;

FIG. 3 is a close-up perspective view of a portion of the clutch pedal assembly of FIGS. 1-2, having a locking element unlocked, according to the principles of the present disclosure;

FIG. 4 is a close-up perspective view of a portion of the clutch pedal assembly of FIGS. 1-3 locked in a performance state, in accordance with the principles of the present disclosure; and

FIG. 5 is a close-up perspective view of a portion of another clutch pedal assembly, in accordance with the principles of the present disclosure.

### DETAILED DESCRIPTION

The following description is merely exemplary in nature and is not intended to limit the present disclosure, application, or uses.

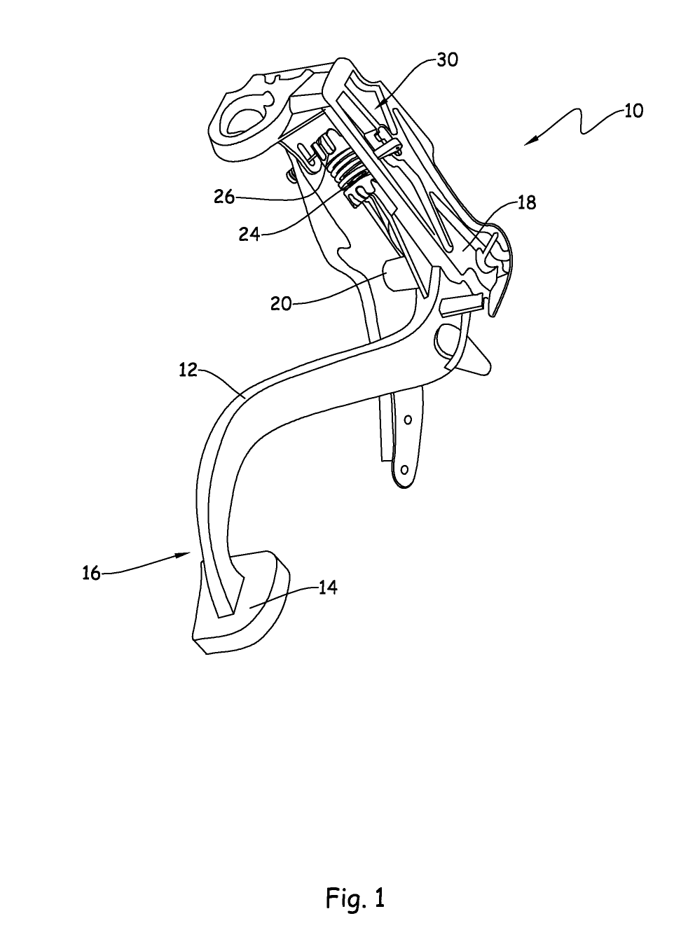

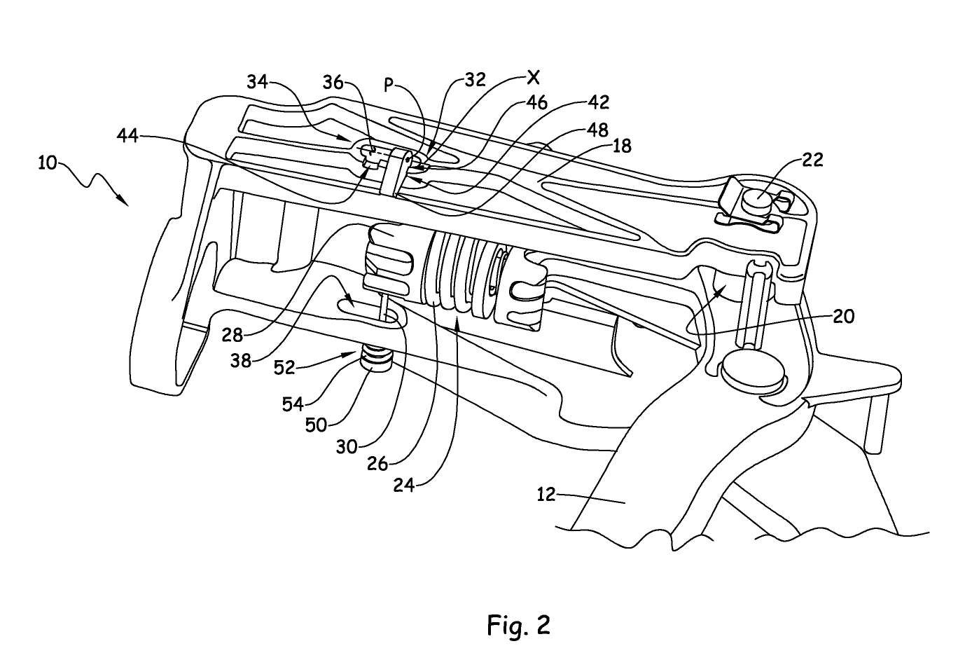

With reference to FIGS. 1-2, a clutch pedal assembly for an automotive transmission is illustrated and generally designated at 10. The clutch pedal assembly includes a clutch pedal lever 12 for disengaging a clutch of a vehicular transmission. The clutch pedal lever 12 may have a stepping plate 14 at a lower end 16 for allowing a user to depress the clutch pedal lever 12 with his/her foot.

The clutch pedal lever 12 has a depressed position and a return position. For example, in the depressed position, e.g., when a user/driver has depressed the clutch pedal lever 12 by applying a force to the stepping plate 14, the clutch or clutches of the transmission may be in a disengaged position. In the return position, no force is applied by the driver to the clutch pedal lever 12, and therefore, the clutch pedal level 12 has not disengaged the clutch or clutches of the transmission. In other words, the force applied to the clutch pedal lever 12 is transmitted hydraulically to the clutch or clutches (not shown) to disengage the clutch or clutches. There may also be an intermediate position, or assist position, wherein the user/driver has partially depressed the clutch pedal lever 12, which will be described in further detail below.

The clutch pedal lever 12 may be pivotally attached to a structural clutch member 18 or other structure that is affixed to the vehicle. For example, the clutch pedal lever 12 may be connected to the structural clutch member 18 at a pivot point 20. At the pivot point 20, a pivot pin 22 may extend through the clutch pedal lever 12 and the structural clutch member 18 such that the clutch pedal lever 12 is rotatably attached to the structural clutch member 18 at the pivot point 20.

The clutch pedal lever 12 is coupled to a biasing member 24, which may include one or more coil springs 26 coupled to a surrounding structure 28, by way of example. The biasing member 24 is configured to bias the clutch pedal lever 12 into the depressed position. In other words, the biasing member 24 is configured to reduce the pedal force required to depress the clutch pedal lever 12 and to disengage the clutch or clutches of the transmission.

The clutch pedal lever 12 may have an intermediate position, or assist position, between the return position and the depressed position, wherein the biasing member 24 is configured to assist in depressing the clutch pedal lever into the depressed position after the clutch pedal lever 12 reaches the intermediate position. For example, the clutch pedal lever 12 starts out in the return position and a force is required to press the clutch pedal lever 12 into the intermediate position. Once the user applies sufficient force to move the clutch pedal lever 12 from the return position to the intermediate position, the biasing member 24 assists the user in depressing the clutch pedal lever 12 into the depressed position. Thus, the biasing member 24 is configured to bias the clutch pedal lever 12 into the depressed position when the clutch pedal lever 12 is located anywhere from the intermediate position to the depressed position. The biasing member 24, therefore, biases the clutch pedal lever 12 into the depressed position to release the clutch or clutches of the transmission, but not until after initial depression of the clutch pedal lever 12 by the driver.

In some instances, the driver may desire to have a large amount of assistance in depressing the clutch pedal lever 12, which results in a comfortable, easy-to-depress clutch pedal lever 12. However, the biasing member 24 may slow down shifting overall. Therefore, in other instances, the driver may desire little or no assistance from the biasing member 24 in depressing the clutch pedal lever 12. For example, when the driver desires to quickly shift for optimal vehicle performance (when racing, for example), the driver may wish for the biasing member 24 to have little or no effect on shifting.

Accordingly, the biasing member 24 may be selectively fixed to different portions of the structural member 18 to adjust the amount of force that the biasing member 24 provides to assist with depressing the clutch pedal lever 12. As shown in FIG. 2, a rod 30 is coupled to the surrounding structure 28 of the biasing member 24. The rod 30 is selectively connectable to a first portion 32 of the structural member 18, and the rod 30 is also selectively connectable to a second portion 34 of the structural member 18. In FIG. 2, the rod 30, and thus the biasing member 24, are shown connected to the first portion 32 of the structural member 18.

The structural member 18 defines a slot 36 therein extending from the first portion 32 to the second portion 34 of the structural member 18. The rod 30 is disposed in the slot 36 and is slidable in the slot 36 to move the rod 30 from the first portion 32 to the second portion 34 of the structural member 18. Since the rod 30 is coupled to the biasing member 24, the biasing member 24 is also slidable along the slot 24. In other words, as the rod 30 slides within the slot 36, the biasing member 24 is also moved along the slot 36. When the biasing member 24 is moved along the slot 36 from the first portion 32 to the second portion 26, the coil spring 26 of the biasing member 24 is lengthened and thus, the biasing member 24 has little effect on biasing the clutch pedal lever 12 to the depressed position when the rod 30 is located at the second portion 34 of the structural member 18.

As shown in FIG. 2, the biasing member 24 is selectively connected to the first portion 32 of the structural member 18 in a comfort state of the clutch pedal lever 12. In the comfort state, the biasing member 24 is locked in a position nearest to the clutch pedal lever 12. After the rod 30 is slid along the slot 36, the biasing member 24 is selectively connected to the second portion 34 of the structural member 18 in a performance state of the clutch pedal level 18, wherein the biasing member 24 is locked in a position furthest from the clutch pedal lever 12 along the slot 36.

The clutch pedal assembly 10 requires a first force to press the clutch pedal lever 12 from the return position to the depressed position in the comfort state, and the clutch pedal assembly 10 requires a second force to press the clutch pedal lever 12 from the return position to the depressed position in the performance state. The second force is greater than the first force because the effect of the biasing member 24 in assisting in depression of the clutch pedal lever 12 is greatly diminished when the biasing member 24 is anchored to the second portion 34 of the structural member 18. Therefore, as the biasing member 24 is moved along the slot 36 from the first portion 32 to the second portion 34, the force required to depress the clutch pedal lever 12 increases. The biasing member 24 is described as being selectively connectable to the first and second portions 32, 34 of the structural clutch member 18, but it should be understood that the rod 30 and biasing member 24 may be connected to any portion of the structural clutch member 18 along the slot 36.

The rod 30 may also extends through a second slot 38 of the structural member 18, to help provide structural stability. In the illustrated embodiment, the rod 30 is disposed through both the first and second slots 36, 38 of the structural member 18.

A locking part 40 is coupled to the biasing member 24 for selectively connecting the biasing member 24 to the first and second portions 32, 34 of the structural member 18. The locking part 40 is configured to selectively lock the biasing member 24 to the first and second portions 32, 34 of the structural member 18. In the illustrated embodiment, the first portion 32 of the structural member 18 defines a first groove 42, and the second portion 34 of the structural member 18 defines a second groove 44. The locking part 40 is disposed in the first groove 42 in the comfort state, and the locking part 40 is disposed in the second groove 44 in the performance state.

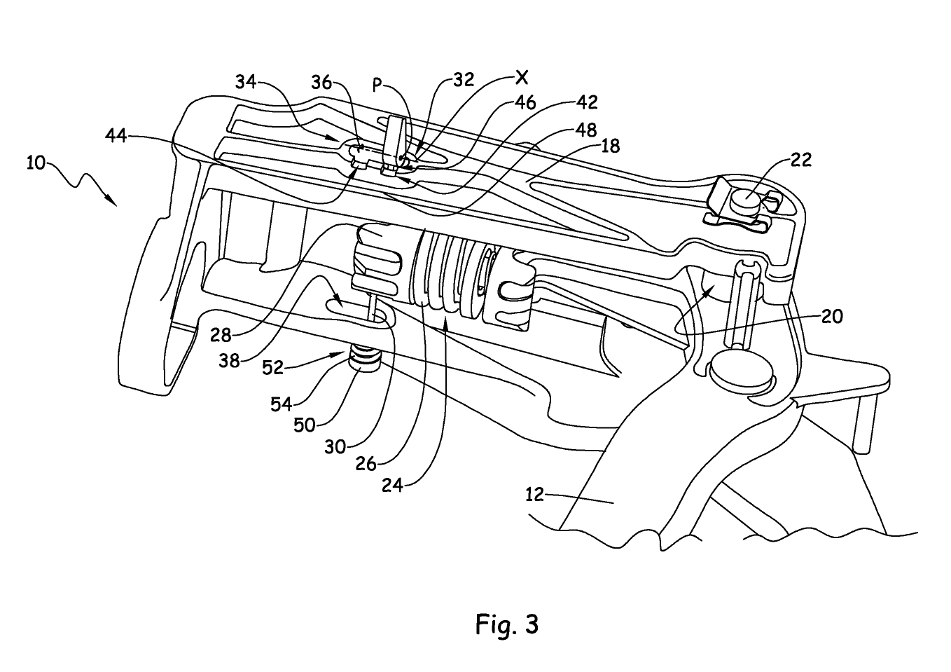

In the illustrated embodiment, the locking part 40 is disposed on a first end 46 of the rod 30. The locking part 40 is a cam brake mechanism having a rounded edge that rotates on an axis of a pivot point P. The locking part 40 has a flat edge 48 adjacent to the rounded edge. The flat edge 48 is disposed in the first groove 42 to lock the locking part 40, rod 30, and biasing member 24 to the first groove 24, as shown in FIG. 2. Referring to FIG. 3, the locking part 40 has been rotated out of the first groove 42 on the pivot point P, 90 degrees along the axis X of the pivot point P, to disengage the locking part 40 from the first groove 42. Once the locking part 42 is disengaged from the first groove 42, the rod 30 may be slid in the first and second slots 36, 38.

In the example provided, the rod 30 has an end stop 50 disposed on a second end 52 of the rod 30. A rod biasing member 54, such as a spring, is disposed around the rod 30 adjacent to the end stop 50. The locking part 40 is configured to be moved away from the first groove 42 by pulling the locking part 40 in a direction away from the structural member 18. When the locking part 40 is pulled by a user away from the structural member 18, the spring 54 is compressed between the end stop 50 and the structural member 18. This allows the rod 30 to be slid freely within the slots 36, 38 without the locking element 40 interfering with the structural member 18 and hindering movement of the rod 30. Accordingly, as shown in FIG. 3, the locking part 40 can be flipped out of either of the first and second grooves 42, 44 (by rotating the locking part 40 ninety degrees along the axis X of the pivot point P) and pulled to compress the spring 54 against the structural member 18.

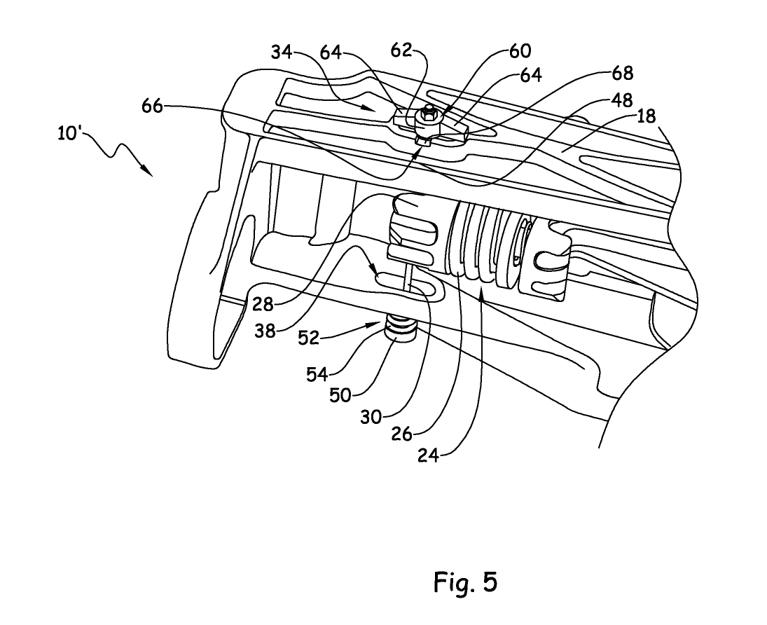

As shown in the Figures, only two grooves 42, 44 for locking the locking element 40 to the structural clutch member 18 are illustrated, however it should be understood that any number of grooves 42, 44 could be provided, such as an intermediate groove (see FIG. 5) located between the first and second grooves 42, 44. Locking the biasing member 24 to an intermediate portion of the slot 36 could result in a medium amount of required pedal force to disengage the clutch, which would be higher than the force required to depress the clutch pedal lever 12 when the rod 30 is located at the first portion 32 and lower than the force required to depress the clutch pedal lever 12 when the rod 30 is located at the second portion 34 of the structural clutch member 18.

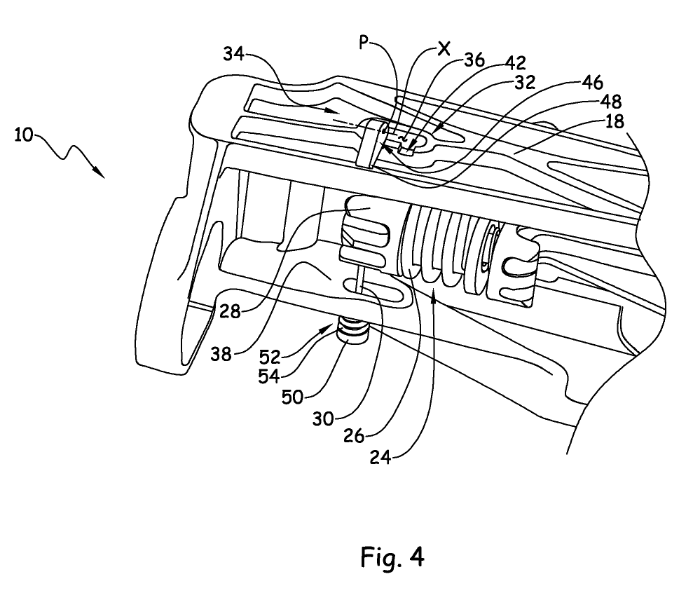

Referring to FIG. 4, the rod 30, biasing member 24 and locking element or part 40 have been slid along the slots 36, 38, and the locking element 40 has been rotated into the second groove 44. Accordingly, the locking element 40 is selectively connectable to the second groove 44 by rotating the locking element 40 along the pivot point P and seating the locking element 40 in the second groove 44.

Once the biasing member 24 is connected to the second portion 34 of the structural member 18, the assembly 10 is in the performance state whereby the biasing member 24 has little or no effect on the clutch pedal lever 12. In other words, the biasing member 24 provides little or no aid in depressing the clutch pedal lever 12. Accordingly, the clutch pedal lever 12 may be quickly depressed to quickly shift the vehicle.

Referring to FIG. 5, another variation of the clutch pedal assembly 10′ is illustrated. Like the clutch pedal assembly 10 shown in FIGS. 1-4, the clutch pedal assembly 10′ may have the same parts except for those that are shown differently in FIG. 5. For example, the clutch pedal assembly 10′ includes the clutch pedal lever 12 coupled to the biasing member 24, which may be coupled to a rod 30 that is selectively connectable to a structural member 18. The rod 30 may be disposed through first and second slots 34, 36, and an end stop 50 may be disposed on a second end 52 of the rod, with a rod biasing member 54 disposed between the end stop 50 and the structural member 18.

In FIG. 5, a threaded member 60 is threaded to the first end 46 of the rod 30. The threaded member 60 has a hub 62 with two wing portions 64 extending from the hub 62; however, the threaded member 60 could have any suitable configuration. The threaded member 60 is configured to selectively fix the rod 30 to the structural member 18. For example, the threaded member 60 may be tightened and loosened on the rod 30 to fix the rod 30 and the biasing member 24 to the first portion 32 of the structural member 18, the second portion 34 of the structural member 18, or an intermediate portion 66 of the structural member 18.

In this example, the intermediate portion 66 has a groove 68 for seating the wing portions 64 of the threaded member 60 to the structural clutch member 18; however, it should be understood that the structural clutch member 18 could have any or none of the first, second, and intermediate grooves 42, 44, 68. The threaded member 60 may be held to the structural clutch member 18 by friction forces as the threaded member 60 is twisted on the rod 30 to tighten the threaded member 60 against the structural clutch member 18.

The rod 30 may be slid along the slots 36, 38 to selectively connect the rod 30 and biasing member 24 to the first portion 32, the second portion 34, the intermediate portion 66 or any other portion in between along the slot 36 of the structural clutch member 18. As such, the degree to which the biasing member 24 assists the user in depressing the clutch pedal lever 12 may be adjusted as explained above.

Thus, the clutch pedal assemblies 10, 10′ provide a driver-selectable anchor point on the structural clutch member 18, at the first or second portion 32, 34 or anywhere in between along the slot 36 of the structural clutch member 18. In some variations, the slot 36 could be about 20 mm long, by way of example. When a driver wants comfort, the biasing member 24 is locked to the first portion 32, which is nearest to the clutch pedal lever 12. When the driver desires maximum performance, the anchor point of the biasing member 24 (locking element 40) is unlocked and moved to the furthest distance from the clutch pedal lever 12 along the slot 36, to the second portion 34 of the structural member 18. The mechanism for adjusting the assist-spring load is attached to the clutch pedal assembly 10, 10′ with no opportunity to separate or lose any part of the assist biasing member 24.

The description of the invention is merely exemplary in nature and variations that do not depart from the gist of the invention are intended to be within the scope of the invention. Such variations are not to be regarded as a departure from the spirit and scope of the invention. For example, the various features shown and described may be combined in any suitable manner.

What is claimed is:

1. A clutch pedal assembly for an automotive transmission, the clutch pedal assembly comprising:
a clutch pedal lever for disengaging a clutch of a vehicular transmission, the clutch pedal lever having a depressed position and a return position;
a biasing member coupled to the clutch pedal lever, the biasing member configured to bias the clutch pedal lever into the depressed position; and
a structural member having a first portion and a second portion, the biasing member being selectively connectable to the first and second portions of the structural member.

2. The clutch pedal assembly of claim 1, wherein the biasing member is selectively connected to the first portion of the structural member in a comfort state of the clutch pedal lever, and the biasing member is selectively connected to the second portion of the structural member in a performance state of the clutch pedal level, the clutch pedal assembly requiring a first force to press the clutch pedal lever from the return position to the depressed position in the comfort state, the clutch pedal assembly requiring a second force to press the clutch pedal lever from the return position to the depressed position in the performance state, the second force being greater than the first force.

3. The clutch pedal assembly of claim 2, wherein the structural member defines a slot therein extending from the first portion to the second portion of the structural member, the biasing member being slidable along the slot.

4. The clutch pedal assembly of claim 3, further comprising a locking part coupled to the biasing member, the locking part being configured to selectively lock the biasing member to the first and second portions of the structural member.

5. The clutch pedal assembly of claim 4, wherein the biasing member comprises a spring.

6. The clutch pedal assembly of claim 5, further comprising a rod coupled to the biasing member, the rod being disposed through the slot of the structural member.

7. The clutch pedal assembly of claim 6, wherein the first portion of the structural member defines a first groove and the second portion of the structural member defines a second groove, the locking part being disposed in the first groove in the comfort state and the locking part being disposed in the second groove in the performance state, the rod being slidable within the slot between the first portion and the second portion of the structural member.

8. The clutch pedal assembly of claim 7, wherein the locking part is disposed on a first end of the rod, the slot being a first slot, the structural member defining a second slot therein, the rod being slidably disposed in the second slot.

9. The clutch pedal assembly of claim 8, the biasing member being a pedal biasing member, the clutch pedal assembly further comprising an end stop disposed on a second end of the rod and a rod biasing member disposed adjacent to the end stop, the locking part being configured to be moved away from the first and second grooves and to compress the rod biasing member between the end stop and the structural member.

10. The clutch pedal assembly of claim 9, the clutch pedal further comprising an intermediate position between the depressed and the return positions, the pedal biasing member being configured to bias the clutch pedal lever into the depressed position only when the clutch pedal lever is located between the intermediate position and the depressed position.

11. The clutch pedal assembly of claim 10, wherein the clutch pedal lever is pivotally coupled to the structural member.

12. The clutch pedal assembly of claim 10, the locking part being rotatable about a pivot point to engage and disengage the locking part from the first and second grooves.

13. The clutch pedal assembly of claim 7, further comprising a threaded member threaded onto the rod, the threaded member being configured to selectively fix the rod to the structural member.

14. A clutch pedal assembly for an automotive transmission, the clutch pedal assembly comprising:
a structural member having a first portion and a second portion, the first portion defining a first groove therein and the second portion defining a second groove therein;
a clutch pedal lever for disengaging a clutch of a vehicular transmission, the clutch pedal lever having a depressed position and a return position, the clutch pedal lever being rotatably coupled to the structural member; and
a pedal biasing member coupled to the clutch pedal lever;
a locking element coupled to the pedal biasing member, the locking element selectively connectable to the first and second portions of the structural member in the first and second grooves.

15. The clutch pedal assembly of claim 14, wherein the structural member defines a slot extending from the first portion to the second portion, the clutch pedal assembly further comprising a rod attached to the pedal biasing member, the rod being disposed in the slot, the rod being coupled to the locking element.

16. The clutch pedal assembly of claim 15, wherein the slot is a first slot, the structural member further defining a second slot therein, the rod being disposed in the second slot, the locking element being disposed in the first groove in a comfort state and the locking element being disposed in the second groove in a performance state, the rod being slidable within the first slot between the first portion and the second portion of the structural member.

17. The clutch pedal assembly of claim 16, wherein the clutch pedal assembly requires a first force to press the clutch pedal lever from the return position to the depressed position in the comfort state, the clutch pedal assembly requiring a second force to press the clutch pedal lever from the return position to the depressed position in the performance state, the second force being greater than the first force.

18. The clutch pedal assembly of claim 17, wherein the locking element is disposed on a first end of the rod, the clutch pedal assembly further comprising a further comprising an end stop disposed on a second end of the rod and a rod biasing member disposed adjacent to the end stop, the locking element being configured to be moved away from the first and second grooves and to compress the rod biasing member between the end stop and the structural member.

19. The clutch pedal assembly of claim 18, the clutch pedal further comprising an intermediate position between the depressed and the return positions, the pedal biasing member being configured to bias the clutch pedal lever into the depressed position only when the clutch pedal lever is located between the intermediate position and the depressed position.

20. A clutch pedal assembly for an automotive transmission, the clutch pedal assembly comprising:
a clutch pedal lever for disengaging a clutch of a vehicular transmission, the clutch pedal lever having a depressed position, an intermediate position, and a return position;
a pedal biasing member coupled to the clutch pedal lever;
a structural member having a first portion defining a first groove therein and a second portion defining a second groove therein, the structural member defining a first slot therein extending from the first portion to the second portion, the structural member further defining a second slot therein, the clutch pedal lever being pivotally coupled to the structural member;
a rod coupled to the pedal biasing member, the rod being disposed through the first and second slots of the structural member, the rod being slidable within the first slot between the first portion and the second portion of the structural member, the rod having a first end and a second end;
a locking part coupled to the first end of the rod, the locking part being configured to selectively lock the pedal biasing member to the first portion of the structural member in the first groove in a comfort state, the locking part being configured to selectively lock the pedal biasing member to the second portion of the structural member in the second groove in a performance state;
an end stop disposed on the second end of the rod; and
a rod biasing member disposed adjacent to the end stop, the locking element being configured to be moved away from the first and second grooves and to compress the rod biasing member between the end stop and the structural member,
wherein the clutch pedal lever requires a first force to press the clutch pedal lever from the return position to the depressed position in the comfort state, the clutch pedal lever requiring a second force to press the clutch pedal lever from the return position to the depressed position in the performance state, the second force being greater than the first force, the pedal biasing member being configured to bias the clutch pedal lever into the depressed position when the clutch pedal lever is located between the intermediate position and the depressed position.
